(19) United States
(12) Patent Application Publication
(10) Pub. No.: US 2015/0058121 A1
(43) Pub. Date: Feb. 26, 2015

(54) SYSTEM AND METHOD FOR CONTROLLING TARGETED ADVERTISING

(71) Applicant: Ghostery, Inc., New York, NY (US)

(72) Inventor: Thomas Navin, Nutley, NJ (US)

(21) Appl. No.: 14/465,389

(22) Filed: Aug. 21, 2014

Related U.S. Application Data
(60) Provisional application No. 61/868,347, filed on Aug. 21, 2013.

(51) Int. Cl. G06Q 30/02; H04L 29/08

(52) U.S. Cl. CPC G06Q 30/0255; H04L 67/22
USPC 705/14.53

(57) ABSTRACT

In a system enabling a user to control tracking of online activities of the user on a user device, a list of trackers is presented to the user. For each tracker, an option to opt out of or opt in into tracking by that tracker is also presented. The user's preference for a particular tracker, i.e., opt out or opt in, is transmitted to the tracker via a message that includes the specific ID or IDs used by that particular tracker.

### CROSS-REFERENCE TO RELATED APPLICATIONS

This application claims priority to and benefit of U.S. Provisional Patent Application No. 61/868,347 entitled “A System and Method for Controlling Targeted Advertising,” filed on Aug. 21, 2013, the entire contents of which are incorporated herein by reference.

### FIELD OF THE INVENTION

The present invention generally relates to online advertisement systems, and more particularly to systems for controlling user behavior tracking.

### BACKGROUND OF THE INVENTION

Using the Internet, people can freely access information in many diverse areas such as science, literature, fine arts, business, and entertainment. One factor contributing to the free availability of such content to a user is the revenue generated from online advertising. In order to make an advertisement relevant and interesting to a user, which can increase the advertisement revenue, some systems employ behavioral targeting. In behavioral targeting, the user's online activities and/or data relating to offline activities, such as the websites visited, time spent on a certain website, etc., are tracked, and the user's interests are determined from the tracked data. Advertisements are then selected for delivery to the user based on the determined user interest.

Behavioral targeting is controversial as it can be beneficial in some instances but intrusive in other instances. For example, a person searching for restaurants or a cuisine of a particular kind may like to receive a coupon from or an advertisement about a restaurant. A person researching a medical condition, however, may prefer that the user's activities are not tracked and used in serving advertisements. One way to avoid or minimize undesired behavioral targeting is to let a user opt out of such targeting. Currently available methods for opting in or opting out can be effective on conventional computers (e.g., desktops, laptops, etc.) in controlling cookie-based targeting, but they are not effective in environments that do not allow/support control of cookies such as mobile applications and some browsers. The current techniques are also not effective in controlling various other types of tracking techniques that may be used—particularly in connection with mobile devices and applications, and some browsers.

A common way of collecting online user activity is cookie-based tracking. Users can control such tracking by either permitting the use of cookies or by disabling their use altogether. Thus, the user must either forego all benefits of targeted advertising or must forego any privacy concerns. Some applications, such as browsers, allow a user to set a default (e.g., cookies are disabled) and allow the user to list excluded websites, i.e., websites that may store cookies and thus track user activity. The control offered by this technique is significantly limited, because the user must have knowledge of whether a certain website provides beneficial advertisements (or performs intrusive tracking, if the default is to permit cookies), so that that website may be excluded from the default condition. Moreover, such control is usually provided via a browser, and as such, cannot control tracking via other software such as mobile apps.

As behavioral targeting has gained popularity, tracking performed using browser extensions and/applications is not limited only to cookie-based tracking. Instead, many different kinds of IDs, such as UDID, OpenUDID, MAC Address, Device Fingerprint ID, and Android ID, are used for tracking. This presents additional challenges to controlling tracking. First, in many instances a user is simply unaware that the user's activities are being tracked using a certain kind of ID. Second, even if the user has such knowledge, the browser and/or applications may not provide a mechanism to opt in or opt out—thereby permitting or preventing tracking using these different IDs, according to the user's preference.

According to one technique, an opt-out cookie may indicate that the user has opted out of data collection, tracking, and/or delivery of targeted messages by a particular tracking technology or tracking company. Per the Digital Advertising Alliance (DAA) regulations, the tracking technology/company may observe the opt-out cookie and may not collect user data or track user activity, and may not deliver targeted ads to the user, whether the tracking technology/company used cookies or other IDs for tracking. This technique requires that the user provide the opt-out cookie. As described earlier, the user is often unaware of tracking by a particular tracking technology/company, and as such, the user does not provide the opt-out cookie. Also, user's frequently delete all cookies from their devices, and then, the opt-out cookie may also be deleted.

Some mobile applications that may provide control of tracking by other mobile applications require custom integration of the control application with the software development kit (SDK) of the application that tracks user activity. Then, the control application may assign its own proprietary opt-out ID, with which a partner, i.e., provider of the mobile application that tracks user activity must synchronize. For example, the SDK of the control application, i.e., the trusted system is built into the SDK of the tracking platform. Then, proprietary opt-out IDs are assigned to the user to monitor the user's opt in/opt out preferences, and the tracking application may consider the user's preference by reading the proprietary opt-out IDs. This kind of integration of two different applications provided by different vendors can be cumbersome or even infeasible. As such, this control technique may also be ineffective in many situations. Therefore, there is a need for an improved system and/or method that can enable users to control tracking of their online activities.

### SUMMARY OF THE INVENTION

Various embodiments of the present invention enable a user to effectively control delivery of targeted messages (e.g., advertisements, promotions, etc.) to the user regardless of the type of IDs used to track the user's activity. Various embodiments also enable a provider of such messages to learn of a user's preference and to respond thereto. This is achieved, in part, by receiving notification that a provider of a targeted message is using an ID of a certain type to track user activity. A tracker (i.e., the entity tracking user activity) may alert a user of the delivery of a targeted message and/or tracking by that tracker by placing an indicator, such as the AdChoices icon, on top of the targeted message presented to the user.

When the user responds to the indicator (e.g., clicks or taps on the AdChoices icon), the user is notified of the likely tracking and the identity of the message provider/tracker. The user's preference with respect to the tracking by that tracker is sought, and if the user chooses to opt-out, that preference is communicated to the tracker and/or the tracking platform using an ID used by that tracker, so that the tracker/tracking platform may no longer deliver targeted messages to the user.

Accordingly, in one aspect, a method allowing for control of user activity tracking includes presenting by an analyzer to a user an option to opt out of tracking by a tracker, where the tracker uses an ID of a particular ID type to collect user activity data at a user device. The analyzer can be implemented by a processor on the user device. The method also includes retrieving an ID of the particular type and corresponding to the user and/or the user device. In addition, the method includes, in response to the user choosing to opt out of tracking by the tracker, notifying the tracker of the user preference via a message that includes the retrieved ID. The user device may include a mobile device such as a cellular phone, a smart phone, a tablet, a laptop computer, a wearable device such as glasses, watch, etc. The ID may include one or more of UDID, OpenUDID, IDFA, MAC Address, Android ID, Android Phone ID, a fingerprinting ID, and/or other types of IDs that may be developed in the future.

In some embodiments, presenting to the user the option to opt out includes displaying a list of several of trackers, and presenting an option to opt out of tracking by each tracker on the list. Each of the several trackers may be associated with an indicator that is displayed on the user device by any one of the trackers. The indicator, e.g., an icon, may be provided by a third party to at least some of the trackers on the list, for display thereof along with a message (advertisement, promotion, etc.) provided by a tracker to the user device.

In some embodiments, retrieving the ID includes accessing from a database a list of types of IDs used by the tracker. For each ID type, an ID of that type may be obtained on the user device, e.g., using application program interfaces (APIs), requesting information from the operating system, etc. The database may be stored at the user device and/or at a remote server. In one embodiment, the particular ID type includes fingerprinting ID. As such, retrieving the ID includes executing a fingerprinting code on the user device to generate a fingerprinting ID corresponding to the user device. Alternatively or in addition, the ID used by the tracker may include a proprietary ID, and retrieving the ID may include obtaining the proprietary ID from the tracker. The step of retrieving the ID may be performed in response to the user choosing to opt out of tracking by the tracker. Notifying the user preference may include transmitting a message that includes the retrieved ID to the tracker. The collection of the user activity data may occur during web browsing and/or running of an application by the user on the user device.

In another aspect, a system includes a first processor and a first memory coupled to the first processor. The first memory includes instructions which, when executed by a processing unit associated with a user device, program the processing unit to perform a number of tasks listed below. The processing unit includes the first processor or a second processor, or both. The processing unit is also coupled to a memory module that includes the first memory or a second memory, or both. In one embodiment, the instructions are executed by the first processor itself. In another embodiment, the second processor and/or the second memory receive the instructions from the first processor and/or first memory through a network (e.g., the Internet) for execution of the instructions by the second processor. The second processor may be included in the user device.

The instructions program the processing unit to present to a user an option to opt out of tracking by a tracker. The tracker may use an ID of a particular ID type to collect user activity data at the user device. The instructions also program the processing unit to retrieve an ID of the particular type and corresponding to the user or the user device. Moreover, the instructions program the processing unit to notify the tracker of the user preference via a message that includes the retrieved ID, in response to the user choosing to opt out of tracking by the tracker. The user device may include a mobile device. The ID may include one or more of UDID, OpenUDID, IDFA, MAC Address, Android ID, Android Phone ID, fingerprinting ID, and any future developed IDs.

In some embodiments, the instructions, in order to present to the user the option to opt out, further program the processing unit to display a list of a number of trackers, and present an option to opt out of tracking by each tracker on the list. Each of the several trackers may be associated with an indicator that may be displayed on the user device by any one of the trackers. In some embodiments, the instructions, in order to retrieve the ID, further program the processing unit to access from a database a list of types of IDs used by the tracker. In addition, for each ID type, the instructions may program the processor to obtain on the user device an ID of that type. The database may be stored at the user device and/or at a remote server.

In some embodiments, the particular ID type includes fingerprinting ID, and the instructions, in order to retrieve the ID, further program the processing unit to execute a fingerprinting code to generate a fingerprinting ID corresponding to the user device. In some embodiments, the ID used by the tracker includes a proprietary ID, and the instructions, in order to retrieve the ID, further program the processing unit to obtain the proprietary ID from the tracker.

The instructions may program the processing unit to retrieve the ID in response to the user choosing to opt out of tracking by the tracker. In order to notify the user preference, the instructions may program the processing unit to transmit a message to the tracker that includes the retrieved ID. The collection of the user activity data may occur during web browsing by the user on the user device and/or running of an application by the user on the user device.

### BRIEF DESCRIPTION OF THE DRAWINGS

Various embodiments of the present invention taught herein are illustrated by way of example, and not by way of limitation, in the figures of the accompanying drawings, in which:

FIGS. 1A and 1B depict a flow that include receiving notification of tracking ID type and/or ID, receiving user preference, and communicating the user preference to the tracker, according to one embodiment.

### DETAILED DESCRIPTION OF THE INVENTION

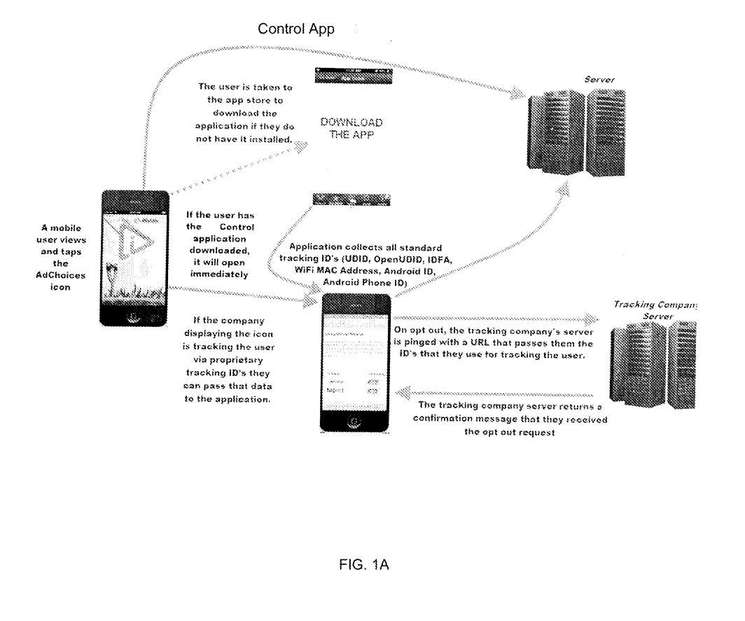

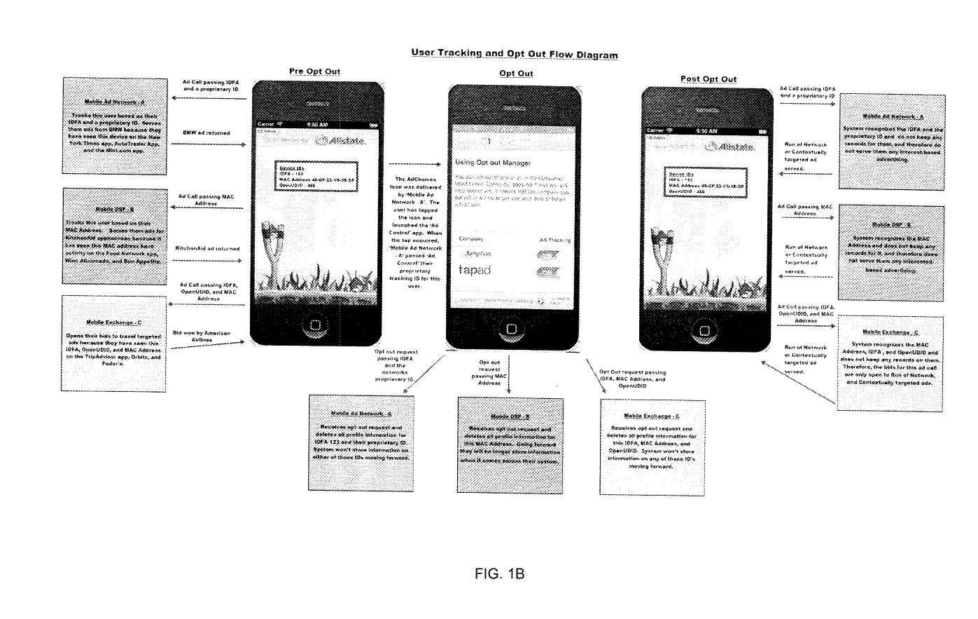

With reference to FIGS. 1A and 1B, an indicator (e.g., the AdChoices icon) is displayed on a mobile device (e.g., a cell phone, smart phone, PDA, Blackberry, tablet PC, laptop, etc.), along with a message (e.g., an advertisement) delivered within an application. The code for displaying the indicator/icon may be supplied by the message provider/advertiser or by the network, demand-side platform (DSP), ad exchange, etc., running an advertisement. Various embodiments are configured to operate on desktop computers and other types of computing devices, as well. According to the DAA guidelines, the entity performing tracking and/or delivering a targeted message is required to display the indicator/icon. The indicator/icon itself can, however, be provided by a third party, for subsequent display thereof. The mobile device user, upon viewing the indicator (e.g., the third-party supplied AdChoices icon that is displayed by the advertiser), may decide to click or tap on the displayed indicator/icon. In response, the user is prompted to download a control app (e.g., AdControl app) from an app store, if such an app is not installed already on the user's device. The control app may be supplied by the third party that provided the indicator/icon.

In one embodiment, when a user responds to the displayed tracking indicator/icon, the control application (e.g., AdControl) installed on the user device (e.g., a mobile device) displays an interface listing various tracking entities associated with the indicator/icon. For each tracking entity, an option to opt in or opt out of targeted advertising is also provided in the interface. If the user had previously selected an option with respect to a particular tracker, that option may be preserved, unless the user switches the option. The trackers may be notified, as described below, if a user switches from opt out to opt in. In some embodiments, the opt in or opt out option corresponding only to a particular tracker that displayed the indicator/icon is presented, along with an option enabling the user to see and/or select tracking by all other trackers that are associated with the indicator/icon.

Each tracking entity may use one or more IDs of one or more types for tracking user activity on the user device. Examples of ID types include UDID, OpenUDID, IDFA, MAC Address, Android ID, Android Phone ID, and fingerprinting ID. It should be understood that these ID types are illustrative only and that notification and control of tracking using other types of IDs, including new types that may be developed in the future, are within the scope of various embodiments. Because various embodiments described herein use the ID actually used by a tracker to notify the user's preference to the tracker, these embodiments can readily function with new types of IDs that may be used in the future.

In some embodiments, a database includes information about various tracking entities and the number of IDs and one or more ID types they leverage. The database may be stored locally on the user device or on a server that the control app can access. If a user chooses to opt out of tracking of the user's activity by a particular tracker, the control app obtains all of the IDs that are associated with the user and/or the use device and that are used by that particular tracker. To this end, in one embodiment, the control app can generate a list of the types of IDs (e.g., UUID and Android ID) that that particular tracker uses. For each ID type in the list, the control app the attempts to obtain an ID of that type, e.g., by sending a request for that type of ID to the operating system and/or to an application via an application program interface (API). The obtained IDs would generally correspond to the user or the user device. In one embodiment, instead of collecting the IDs associated with a particular tracker in response to the user choosing to opt out, the one or more IDs used by each tracker associated with the tracking indicator/icon are obtained from time-to-time, e.g., periodically, and may be stored in the database. To maximize user privacy, the database can be stored locally on the user device.

In some embodiments, if the control app determines, using information in the database, for example, that a certain tracker uses a device fingerprint ID, the control app can retrieve the code used to generate the fingerprint ID used by that tracker. The control app can then configure the user device to execute the fingerprinting code and, thus, generate the fingerprint ID. The code used to generate the fingerprint ID can be supplied by a fingerprinting entity that can be the tracker (tracking entity) itself or some other entity. One or more trackers associated with the tracking indicator/icon may use the same fingerprint ID generated using the code provided by the fingerprinting entity.

When the user opts out of tracking by a particular tracker, the control application provides in a message sent to the tracker the IDs used by the tracker, collected and/or generated as described above. The tracking entity's computer may recognize a request from the control application (e.g., AdControl) installed on a user device. Such message can be an http URL ping that can pass the one or more IDs. In one embodiment, an http URL passes the one or more collected tracking IDs of the user back to the corresponding tracking entity via a GET request. Other types of request messages, e.g., POST, may also be used for notification. The request indicates to the tracker/tracking entity that the user prefers to opt out of targeted messages from that tracker. Upon receiving such message (e.g., GET or POST request, and any suitable request method, in general), the tracking entity may acknowledge the message and may no longer track user activity associated with the notified one or more IDs, and may not deliver targeted messages to the user.

If a user opts in, the general mechanism described above can be used to indicate the opt in preference of the user to the tracker, i.e., a message including the one or more IDs that are used by the tracker, and that are collected as described above, is sent to the tracker. In order to distinguish between the message indicating the user's opt in and that indicating the user's opt out, the two message can include a field that has different values for the two options. Alternatively or in addition, different types of messages can be used and/or the message can be sent to different locations associated with the tracker, to inform the tracker whether the tracker should suspend tracking of the user's activity to should engage in such tracking.

In some situations, a tracking entity may use a proprietary ID, i.e., an ID of a type a control application (e.g., AdControl) installed on the user device does not recognize. In that event, when the user responds (e.g., clicks on, taps on, etc.) to the indicator/icon of a delivered message (e.g., an ad), the control app may communicates the corresponding tracking entity, and may receive from the tracking entity the proprietary ID or IDs, configured for the user device. This gives the control app access to the proprietary ID, and the proprietary ID then becomes known to the control application. The control application may associate the proprietary ID with the particular tracking entity, and may store the association in the database described above. Thereafter, tracking of user activity and/or delivery of targeted messages to the user can be controlled via the control application as described above. For example, if the user opts out with respect to the proprietary ID, that ID is passed along in a query string to the tracking platform/tracking entity that uses the proprietary ID. For privacy purposes, the proprietary ID may be held in the application/mobile device memory only for that app session. When the app is closed the data including the proprietary ID may be purged.

Products and/or services vendors often engage one or more trackers to track user activity and to deliver targeted messages (advertisements, promotional messages, etc.), on behalf of those vendors. For any vendor, if a tracker determines that a certain user's activities are relevant to that particular vendor's products and/or services, the tracker may deliver messages from that vendor to the user device. In one example, with reference to FIG. 1B, a car manufacturer (e.g., BMW™) has engaged a tracker Mobile Ad Network—A. In another example, the same car manufacturer engages another tracker, Mobile DSP—B, as well, for tracking user activities, but does not engage other trackers such as Mobile Exchange—C. The indicator that indicates to the user that an advertisement was delivered based on tracking user activity can be customized for each vendor. Thus, if the tracker Mobile Ad Network—A delivered an ad for the car manufacturer, the indicator the tracker can display may be customized for the car manufacturer.

As such, in one embodiment, when the user responds to the indicator (e.g., car manufacturer specific AdChoices icon), instead of presenting a list of various trackers to the user, as described above, the user is informed that a particular vendor (e.g., the car manufacturer) is tracking user activity. The user is then offered a choice to opt out from advertisements, promotional messages etc., for that particular vendor. If the user chooses to opt out, information about all the trackers engaged by the vendor is obtained therefrom. In the example above, such a list would include the trackers Mobile Ad Network—A and Mobile DSP—B, but not Mobile Exchange—C. As described above, the control app can then send a respective message to reach tracker on the list, the respective message including the ID or IDs that are used by the corresponding tracker and that are obtained as described above.

Because various embodiments of the control app recognize the ID employed by the tracking entity itself, these embodiments do not create their own opt-out ID, and do not require the tracking app to recognize the newly created opt-out ID and synchronization therewith. As such, various embodiments of the control app do not require integration with the software development kit (SDK) provided by a tracking company. Instead available infrastructure is used to alert the tracking entities of a user requested opt out. In some embodiments, the control app (e.g., AdControl) does not store opt-out cookies and does not store the user's preference using any browser-specific mechanism. As such, these embodiments can easily and readily control user-activity tracking and/or targeted advertising by various tracking tools and techniques that are presently in use and also by techniques (e.g., different types of IDs) that may be developed in the future. In general, the IDs used to track/know who a user is, are the same IDs that are sent to the tracking platform/tracker to inform the platform/tracker that an opt out has been requested by the user associated with the ID.

From a tracker's perspective, an embodiment of a control application can provide a communication system through which the tracker can learn that a user has requested to opt out (or opt in) of the tracking of the user activity via a third party or tracker-provided application and/or via mobile browsers. As such, the tracking companies can respect users' preferences while delivering the benefits of targeted advertising. From a user's perspective, an embodiment of a control application can provide users with a centralized point to readily see and understand which companies may be tracking the user's activity. Based on this information, the users can conveniently opt out or opt in from such tracking/targeted advertising according to their preference, regardless of the type of IDs used for tracking.

Various embodiments facilitate control of tracking of the user activity and/or targeted advertising when the device lacks the functionality to prevent use of the generic or custom IDs. For example, the device may lack hardware and/or software functionality to prevent the use of MAC Address as ID or a custom ID in behavioral tracking. Moreover, the control is not based merely on the ID type—either permitting all use employing that ID or preventing all use thereof. For example, the user may permit tracking via UUID by one vendor, but may opt out of tracking via UUID by another vendor.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communications protocols to facilitate communications between the different processors/processing elements. The processors can be configured for distributed processing and can utilize, in some embodiments, a client-server model as needed. Accordingly, the methods, devices, and systems can utilize multiple processors and/or processor devices, and the processor/processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communications with other processors, where such one or more processor can be configured to operate on one or more processor/processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific embodiments thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the embodiments disclosed herein, can include practices otherwise than specifically described, and are to be interpreted as broadly as allowed under the law.

Accordingly, we claim:

1. A method allowing for control of user activity tracking, the method comprising performing by an analyzer the steps of:
presenting to a user an option to opt out of tracking by a tracker, the tracker using an ID of a particular ID type to collect user activity data at a user device;
retrieving an ID of the particular type and corresponding to the user or the user device; and
in response to the user choosing to opt out of tracking by the tracker, notifying the tracker of the user preference via a message comprising the retrieved ID.

2. The method of claim 1, wherein the user device comprises a mobile device.

3. The method of claim 1, wherein the ID comprises at least one of UDID, OpenUDID, IDFA, MAC Address, Android ID, Android Phone ID, and fingerprinting ID.

4. The method of claim 1, wherein presenting to the user the option to opt out comprises:
displaying a list of a plurality of trackers; and
presenting an option to opt out of tracking by each tracker on the list.

5. The method of claim 4, wherein each of the plurality of trackers is associated with an indicator displayed on the user device by any one of the trackers.

6. The method of claim 1, wherein retrieving the ID comprises:
accessing from a database a list of types of IDs used by the tracker; and
for each ID type, obtaining on the user device an ID of that type.

7. The method of claim 6, wherein the database is stored at at least one of the user device and a remote server.

8. The method of claim 1, wherein:
the particular ID type comprises fingerprinting ID; and
retrieving the ID comprises executing a fingerprinting code on the user device to generate a fingerprinting ID corresponding to the user device.

9. The method of claim 1, wherein:
the ID used by the tracker comprises a proprietary ID; and
retrieving the ID comprises obtaining the proprietary ID from the tracker.

10. The method of claim 1, wherein the step of retrieving the ID is performed in response to the user choosing to opt out of tracking by the tracker.

11. The method of claim 1, wherein notifying the user preference comprises transmitting a message to the tracker the message comprising the retrieved ID.

12. The method of claim 1, where the collection of the user activity data occurs during at least one of web browsing on the user derive and running of an application on the user device.

13. A system comprising:
a first processor; and
a first memory coupled to the first processor, the first memory comprising instructions which, when executed by a processing unit associated with a user device and comprising at least one of the first processor and a second processor, the processing unit being coupled to a memory module comprising at least one of the first memory and a second memory, program the processing unit to:
present to a user an option to opt out of tracking by a tracker, the tracker using an ID of a particular ID type to collect user activity data at the user device;
retrieve an ID of the particular type and corresponding to the user or the user device; and
in response to the user choosing to opt out of tracking by the tracker, notify the tracker of the user preference via a message comprising the retrieved ID.

14. The system of claim 13, wherein the user device comprises a mobile device.

15. The system of claim 13, wherein the ID comprises at least one of UDID, OpenUDID, IDFA, MAC Address, Android ID, Android Phone ID, and fingerprinting ID.

16. The system of claim 13, wherein the instructions, in order to present to the user the option to opt out, further program the processing unit to:
display a list of a plurality of trackers; and
present an option to opt out of tracking by each tracker on the list.

17. The system of claim 13, wherein each of the plurality of trackers is associated with an indicator displayed on the user device by any one of the trackers.

18. The system of claim 13, wherein the instructions, in order to retrieve the ID, further program the processing unit to:
access from a database a list of types of IDs used by the tracker; and
for each ID type, obtain on the user device an ID of that type.

19. The system of claim 18, wherein the database is stored at at least one of the user device and a remote server.

20. The system of claim 13, wherein:
the particular ID type comprises fingerprinting ID; and
the instructions, in order to retrieve the ID, further program the processing unit to execute a fingerprinting code to generate a fingerprinting ID corresponding to the user device.

21. The system of claim 13, wherein:
the ID used by the tracker comprises a proprietary ID; and
the instructions, in order to retrieve the ID, further program the processing unit to obtain the proprietary ID from the tracker.

22. The system of claim 13, wherein the instructions program the processing unit to retrieve the ID in response to the user choosing to opt out of tracking by the tracker.

23. The system of claim 13, wherein in order to notify the user preference, the instructions program the processing unit to transmit a message to the tracker, the message comprising the retrieved ID.

24. The system of claim 13, where the collection of the user activity data occurs during at least one of web browsing at the user device and running of an application on the user device.
